(19) United States
(12) Patent Application Publication
(10) Pub. No.: US 2010/0274485 A1
(43) Pub. Date: Oct. 28, 2010

(54) Information communication device and navigation system having the same

(75) Inventor: Takashi Tsuchida, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/662,493

(22) Filed: Apr. 20, 2010

(30) Foreign Application Priority Data
Apr. 27, 2009 (JP) 2009-107856

(51) Int. Cl. G01C 21/00; G01S 19/47; H04B 7/00

(52) U.S. Cl. 701/216; 455/41.3

(57) ABSTRACT

A communication unit communicates information via near-field wireless communications. An information generating unit derives a travel distance, by which a movable object moves in a predetermined time period, and generates travel information including at least the generated travel distance. A transmission control unit transmits the generated travel information to a portable navigation device via the communication unit. A GPS receiver receives a signal from a GPS Satellite. A current position deriving unit successively derives a current position according to the signal received by the GPS receiver. A travel information obtaining unit obtains the generated travel information. A position estimating unit estimates an estimated current position moved from a previous current position, which is previously derived by the current position deriving unit, according to the travel information obtained by the travel information obtaining unit.

### CROSS REFERENCE TO RELATED APPLICATIONS

This application is based on and incorporates herein by reference Japanese Patent Application No. 2009-107856 filed on Apr. 27, 2009.

### FIELD OF THE INVENTION

The present invention relates to an information communication device for communicating information with a portable navigation device. The present invention further relates to the portable navigation device. The present invention further relates to a navigation system having the information communication unit and the portable navigation device. The present invention further relates to a method for estimating a current position of a movable object using the navigation system.

### BACKGROUND OF THE INVENTION

Conventionally, a portable navigation device (personal navigation device: PND) is known. Specifically, a conventionally known PND is configured to derive a current position according to a GPS signal received by a GPS receiver, and configured to indicate a marker superimposed on a map around the derived current position to specify the derived current position. The conventionally known PND is further configured to indicate a route from the derived current position to a destination. In many cases, such a PND is carried into in an automobile and used in the automobile. For example, a GPS receiver of such a PND in an automobile cannot receive a GPS signal when the automobile travels through a tunnel, overcrowding buildings, or the like. Consequently, the current position of the automobile cannot be updated. Thus, a user cannot comfortably use such a PND.

In order to solve such a problem, for example, JP-A-2000-311029 proposes to provide an exclusive terminal to an instrument panel of an automobile for outputting a vehicle speed pulse from a vehicle speed sensor of the automobile. According to JP-A-2000-311029, a PND is connected to the exclusive terminal to obtain the vehicle speed pulse via the exclusive terminal, and the PND estimates a travel distance according to the obtained vehicle speed pulse and updates the current position when a GPS signal is not receivable. However, in the structure of JP-A-2000-311029, the PND needs to be connected to the exclusive terminal so as to obtain the vehicle speed pulse. Consequently, an installation position of the PND is limited. Accordingly, an advantage that an installation position of such a PND can be arbitrary changed by a user is spoiled, and usability of the PND is impaired. That is, in the structure of JP-A-2000-311029, both updating of the current position when a GPS signal is not receivable and an arbitrary changeable installation position cannot be simultaneously achieved.

### SUMMARY OF THE INVENTION

In view of the foregoing and other problems, it is an object of the present invention to produce an information communication device enabling a portable navigation device to update a current position of a movable even when a GPS signal is not receivable and enabling the portable navigation device to be arbitrary installed at various positions. It is another object of the present invention to produce the portable navigation device. It is another object of the present invention to produce a navigation system having the information communication unit and the portable navigation device. It is another object of the present invention to produce a method for estimating the current position of the movable object using the navigation system.

According to one aspect of the present invention, an information communication device mounted to a movable object, the information communication device comprises a communication unit for communicating information via near-field wireless communications. The information communication device further comprises an information generating unit configured to derive a derived travel distance, by which the movable object moves in a predetermined time period, and configured to generate travel information including at least the derived travel distance. The information communication device further comprises a transmission control unit configured to transmit the travel information, which is generated by the information generating unit, to a portable navigation device via the communication unit. The portable navigation device includes a GPS receiver configured to receive a signal from a GPS satellite. The portable navigation device further includes a current position deriving unit configured to successively derive a derived current position according to the signal received by the GPS receiver. The portable navigation device further includes a travel information obtaining unit configured to obtain the travel information from the information generating unit. The portable navigation device further includes a position estimating unit configured to estimate an estimated current position moved from a previous derived current position, which is previously derived by the current position deriving unit, according to the travel information obtained by the travel information obtaining unit.

According to another aspect of the present invention, a portable navigation device comprises a GPS receiver configured to receive a signal from a GPS satellite. The portable navigation device further comprises a current position deriving unit configured to successively derive a current position according to the signal received by the GPS receiver. The portable navigation device further comprises a navigation communication unit for communicating information with an information communication device, which is mounted to a movable object, via near-field wireless communications. The portable navigation device further comprises a travel information obtaining unit configured to obtain travel information from the information communication device via the near-field wireless communications by using the navigation communication unit, the travel information being generated by the information communication device to include at least a derived travel distance derived by the information communication device, the derived travel distance specifying a distance, by which the movable object moves in a predetermined time period. The portable navigation device further comprises a position estimating unit configured to estimate an estimated current position moved from a previous current position, which is previously derived by the current position deriving unit, according to the obtained travel information.

According to another aspect of the present invention, a method for estimating a current position of a movable object, the method comprises deriving a travel distance, by which the movable object moves in a predetermined time period, by an information communication device mounted to the movable object. The method further comprises transmitting the derived travel distance by the information communication device to a portable navigation device via near-field wireless communications. The method further comprises obtaining the travel information by the portable navigation device. The method further comprises successively deriving a derived current position by the portable navigation device according to a signal transmitted from a GPS satellite and received by a GPS receiver. The method further comprises estimating an estimated current position, which is presently moved from a previously derived current position, by the portable navigation device according to the previously derived current position and the derived travel distance.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a navigation system;

FIG. 2 is a block diagram showing a travel information communication device;

FIG. 3 is a block diagram showing a portable navigation device;

FIG. 4 is a flow chart showing a procedure of a travel information generating operation;

FIG. 5 is a flow chart showing a procedure of a position data output operation; and

FIG. 6 is a diagram showing an example of an output time point of a vehicle speed and a yaw rate.

### DETAILED DESCRIPTION OF PREFERRED EMBODIMENTS

As follows, embodiments of the present invention will be described with reference to drawings.

<Navigation System>

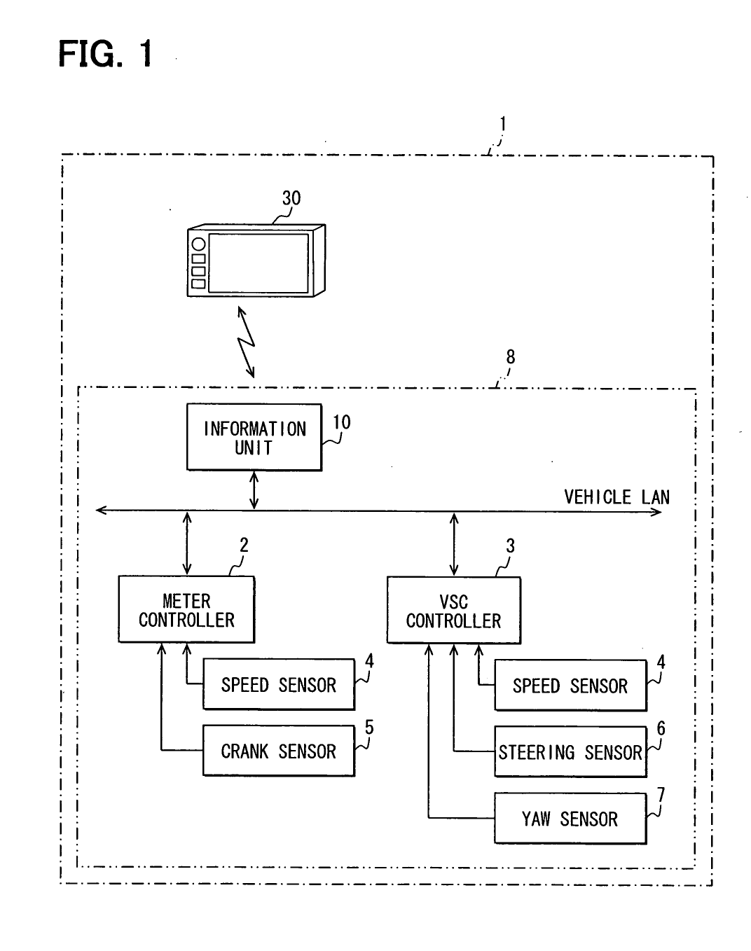

FIG. 1 is a block diagram showing an overview of a navigation system.

A navigation system 1 includes an in-vehicle device group 8 provided in an automobile and a portable navigation device 30, which can be carried by a user. Below, a vehicle mounted with the in-vehicle device group 8 is denoted by a self-vehicle. The in-vehicle device group 8 includes a meter control device 2 and a vehicle stability control system control device (VSC control device) 3.

The meter control device 2 is configured to control indication of a meter device in order to notify an occupant of a state of the self-vehicle. The VSC control device 3 is configured to control a driving and braking mechanism provided to the self-vehicle so as to stabilize the behavior of the self-vehicle. The control devices 2 and 3 are electronic control units independent from each other and mainly configured of an arithmetic processing unit including a microcomputer. Each of the control devices 2 and 3 includes a data communication unit connected to each other via a communication line for data communications. The data communication units are configured to transmit and receive data via each control device and a communication line (in-vehicle LAN). The meter control device 2 is connected with at least a vehicle speed sensor 4 for detecting a vehicle speed of the self-vehicle and a crank angle sensor 5 for detecting a crank angle of an internal combustion engine of the self-vehicle. The meter control device 2 is configured to derive the vehicle speed of the self-vehicle and an engine speed of the internal combustion engine as a state of the self-vehicle based on a detection signal of the sensors. The meter control device 2 is further configured to indicate such a state of the self-vehicle. In addition; the meter control device 2 is configured to output the derived vehicle speed of the self-vehicle at a predetermined interval such as 100 ms via a data communication unit.

The VSC control device 3 is connected with the vehicle speed sensor 4, a steering angle sensor 6 for detecting a steering angle, and a yaw rate sensor 7 for detecting a swing speed (yaw rate) in the yaw direction of the self-vehicle. The VSC control device 3 is configured to derive the vehicle speed and the yaw rate according to the detection signal of the sensors and configured to estimate a traveling state of the self-vehicle. Thus, the VSC control device 3 is configured to control a driving and braking mechanism so as to stabilize the behavior of the self-vehicle. In addition, the VSC control device 3 is configured to output the yaw rate of the self-vehicle via the data communication unit at a specified interval, which is determined beforehand, such as 20 ms. It is noted that the specified distance satisfies: specified interval<set interval.

The in-vehicle device group 8 further includes a travel information communication device 10 (information communication device) configured to derive a traveling distance and a traveling direction of the self-vehicle in a specified time period, which is determined beforehand. The travel information communication device 10 is further configured to output travel information including the traveling distance and the traveling direction to the portable navigation device 30.

<Portable Navigation Device>

As follows, a structure of the portable navigation device 30 will be described. FIG. 3 is a block diagram showing a structure of the portable navigation device 30. The portable navigation device 30 is configured as a personal navigation device (PND). As shown in FIG. 3, the portable navigation device 30 includes a GPS receiver 31, a communication unit 32, an operation reception unit 33, and a display unit 34. The GPS receiver 31 receives an electric wave (GPS signal) from a space satellite of a global positioning system (GPS) via a GPS antenna and outputs the GPS signal. The communication unit 32 exchanges data with the travel information communication device 10. The operation reception unit 33 receives various instructions from a user. The display unit 34 indicates various images. The portable navigation device 30 further includes a voice output unit 35, an auxiliary memory unit 36, and a control unit 37. The voice output unit 35 outputs various kinds of guidance voices. The auxiliary memory unit 36 stores various data such as map data. The control unit 37 controls each of the units 31 to 36 of the portable navigation device 30. The display unit 34 may be a color display device such as a liquid crystal display, an organic electroluminescence (EL) display, a plasma display, a cathode ray tube (CRT), or the like. The voice output unit 35 is configured to convert a signal from the control unit 37 into a voice signal, and outputs a voice according to the voice signal using, for example, a speaker. The operation reception unit 33 includes a touch panel, a key switch, a microphone, and the like. The touch panel is integrated with the display surface of the display unit 34. The key switch is located in, for example, the circumference of the display unit 34. The microphone receives a voice of a user.

The auxiliary memory unit 36 includes a rewritable nonvolatile storage device such as a flash memory. The auxiliary memory unit 36 prestores, for example, map data, voice data for guidance, voice recognition data, and the like. The map data includes, for example, node data, link data, cost data, road data, geographical feature data, mark data, intersection data, facility data, and the like.

The communication unit 32 is configured to exchange data with the travel information communication device 10 via a near-field wireless communication, which conforms to the Bluetooth (registered trademark) standard, for example. The control unit 37 is mainly configured of a generally-known microcomputer including a ROM, a RAM, a CPU, and the like. The control unit 37 is configured to perform a destination setting operation for setting a destination according to information inputted via the operation reception unit 33. The control unit 37 is further configured to perform a route setting operation for setting a route to the destination, which is set by the destination setting operation, in a generally-known method such as a Dijkstra method. The control unit 37 specifies a current position of the portable navigation device 30 and causes the display unit 34 to indicate a map around the specified current position and a current position mark in the map. The control unit 37 is further configured to perform a route guidance operation to guide the destination, which is set through the destination setting operation, and the route, which is set through the route setting operation.

In the route guidance operation, when the GPS receiver 31 is capable of receiving the GPS signal, the control unit 37 determines (derives) the current position according to the GPS signal. On the other hand, when the GPS receiver 31 is incapable of receiving the GPS signal, the control unit 37 estimates the current position according to the travel distance and the traveling direction derived by the travel information communication device 10. Specifically, the control unit 37 specifies (derives) the current position in a generally-known method such as adding a traveling path in a specified time period to a previous current position, which was derived according to the GPS signal, which was most recently received by the GPS receiver 31. That is, the control unit 37 derives the current position according to the GPS navigation when capable of receiving the GPS signal. Alternatively, the control unit 37 derives the current position according to an autonomous navigation based on the travel information from a travel distance computation unit when incapable of receiving the GPS signal. The control unit 37 is further configured to generate position data including at least the derived current position and configured to output the position data via the communication unit 32. The position data includes, in addition to the current position, a state around the current position such as a geographical feature and a distance to a stop line. The geographical feature includes information specifying whether a specific place is a downhill or an uphill, for example. In short, the portable navigation device 30 is a mobile navigation device configured to be carried by a user. In addition, the portable navigation device 30 includes the communication unit configured to perform a near-field wireless communications in compliance with the Bluetooth standard.

<Travel Distance Computation Unit>

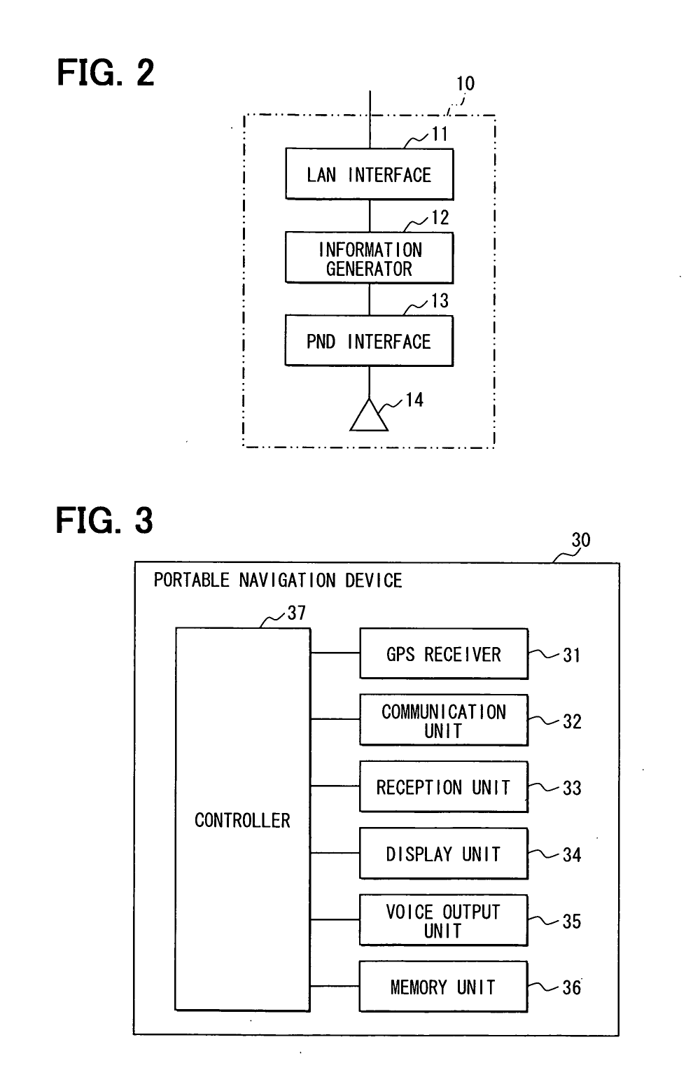

FIG. 2 is a block diagram showing a structure of the travel distance computation unit 10. The travel information communication device 10 includes an in-vehicle LAN interface unit 11, a travel information generating unit 12, and a portable navigation device (PND) interface unit 13. The in-vehicle LAN interface unit 11 obtains the vehicle speed from the meter control device 2. The in-vehicle LAN interface unit 11 further obtains the yaw rate from the VSC control device 3. The travel information generating unit 12 generates travel information (data) according to the vehicle speed and the yaw rate obtained via the in-vehicle LAN interface unit 11. The PND interface unit 13 transmits the travel information, which is generated by the travel information generating unit 12, to the portable navigation device 30 via an antenna 14. The in-vehicle LAN interface unit 11 is communicated with the control devices 2 and 3 via the communication line for data communications and configured to exchange data with the control devices 2 and 3. The PND interface unit 13 is configured to exchange data with the portable navigation device 30 through the antenna 14 via a near-field wireless communications in compliance with the Bluetooth (registered trademark) standard. The travel information generating unit 12 is mainly configured of a generally-known microcomputer including a ROM, a RAM, a CPU, and the like. The travel information generating unit 12 is configured to generate travel information based on the vehicle speed and the yaw rate. The travel information generating unit 12 is further configured to perform a travel information generating operation for transmitting the generated travel information to the portable navigation device 30. The travel information generating unit 12 is further configured to perform a position data output operation for obtaining the position data outputted from the portable navigation device 30 and outputting the obtained position data to another in-vehicle apparatus.

<Travel Information Generating Operation>

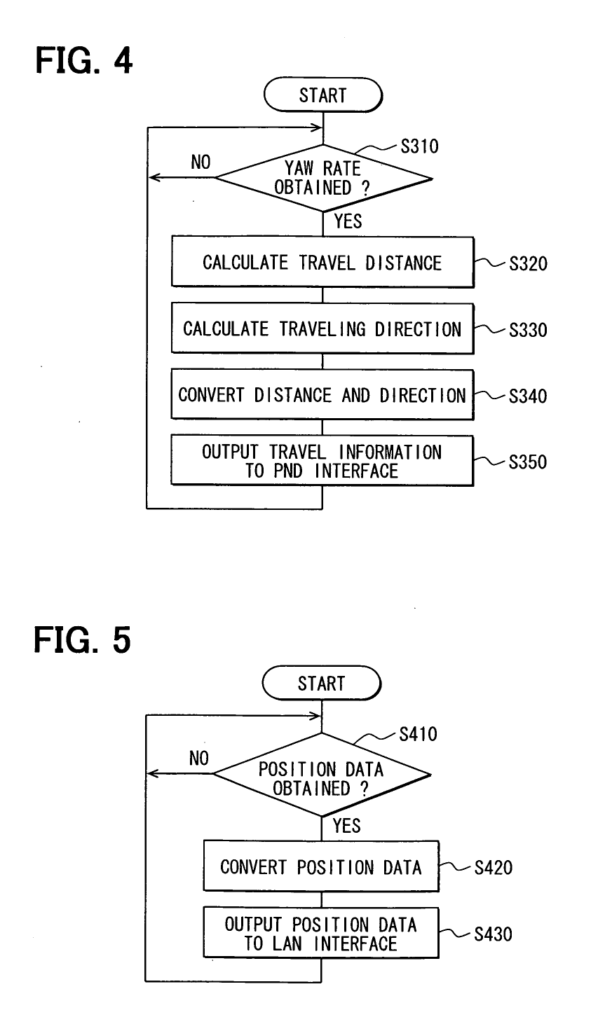

Subsequently, a procedure of the travel information generating operation will be described. The travel information generating operation is performed by the travel information generating unit 12. FIG. 4 is a flow chart showing the travel information generating operation. The travel information generating operation is started when an accessory power supply is activated (ON). In the travel information generating operation at S310, it is determined whether the yaw rate outputted from the VSC control device 3 is obtained via the in-vehicle LAN interface unit 11. When the yaw rate is not obtained, the processing waits until the yaw rate is obtained. When the yaw rate is obtained from the VSC control device 3, at S320, the vehicle speed obtained from the meter control device 2 is multiplied by the specified interval, which is a predetermined time period such as 20 ms. In this manner, The travel distance of the self-vehicle in the specified interval is derived. Subsequently, at S330, the yaw rate obtained at S310 is multiplied by the specified interval such as 20 ms to derive an angle by which the self-vehicle swang in the specified interval. Thus, the traveling direction of the self-vehicle is derived. At S340, the travel distance derived at S320 and the traveling direction derived at S330 are converted into data in a data format, such as a serial data format in general, to be outputted from the PND interface unit 13. That is, at S320 to S340, the travel information, which is to be transmitted from the travel information communication device 10 to the portable navigation device 30, is generated. At S350, the travel information generated at S320 to S340 are outputted to the PND interface unit 13. The PND interface unit 13 transmits the travel information to the portable navigation device 30 via near-field communications in compliance with the Bluetooth (registered trademark) standard. Thereafter, the processing returns to S310 and repeats steps S310 to S350.

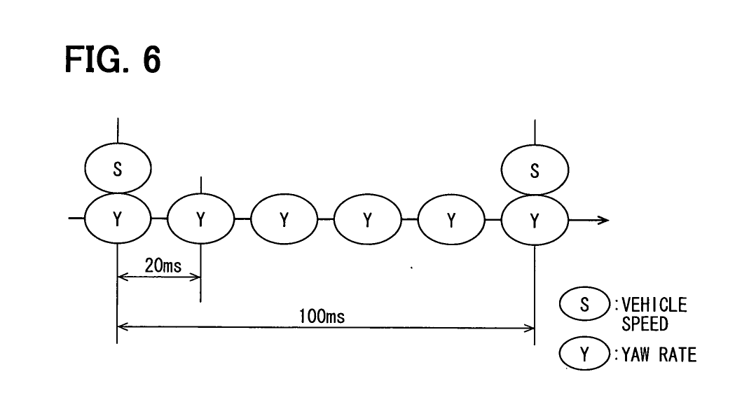

In the present embodiment, as shown in FIG. 6, the VSC control device 3 outputs the yaw rate at the specified interval such as 20 ms, and the meter control device 2 outputs the vehicle speed at a set interval such as 100 ms. Therefore, the in-vehicle LAN interface unit 11 obtains the yaw rate at the specified interval such as 20 ms and obtains the vehicle speed at the set interval such as 100 ms. In the travel information generating operation performed by the travel information generating unit 12, the travel distance of the self-vehicle in the specified interval and the traveling direction are generated as travel information at the specified interval at which the yaw rate is obtained. Thus, the generated travel information is transmitted to the portable navigation device 30.

<Position Data Output Operation>

Subsequently, a procedure of the position data output operation will be described. The position data output operation is performed by the travel information generating unit 12. FIG. 5 is a flow chart showing the position data output operation. The position data output operation is started when the accessory power supply is activated (ON). In the travel information generating operation at S410, it is determined whether the position data from the portable navigation device 30 is obtained via the PND interface unit 13. When the position data is not obtained, the processing waits until the position data is obtained. When the position data is obtained, at S420, the obtained position data is converted to data in a data format, such as a parallel data format in general, to be outputted from the in-vehicle LAN interface unit 11 to the communication line for data communications. Subsequently, the position data converted at S420 is outputted to the in-vehicle LAN interface unit 11. The in-vehicle LAN interface unit 11 outputs the position data to an in-vehicle apparatus specified beforehand. Thereafter, the processing returns to S410 and repeats steps S410 to S430. That is, in the position data output operation, when the position data is obtained from the portable navigation device 30, the received position data is outputted to the in-vehicle apparatus specified beforehand.

<Operation Effect>

As described above, even when the GPS signal is not receivable, the portable navigation device 30 of the navigation system 1 is capable of estimating and updating the current position according to the travel information transmitted from the travel information communication device 10. Furthermore, the travel information communication device 10 according to the present embodiment transmits the travel information by utilizing a near-field wireless communications. Therefore, the portable navigation device 30 may be located at various positions, as long as being capable of receiving the travel information. Thus, a user can arbitrary select the installation position of the portable navigation device 30 in the interior of the self-vehicle. In particular, the travel information communication device 10 according to the present embodiment employs a near-field wireless communications in compliance with the Bluetooth standard. Therefore, even when an object exists between the travel information communication device 10 and the portable navigation device 30, the portable navigation device 30 can receive the travel information. Accordingly, the installation position of the portable navigation device 30 can be further arbitrary determined. In other words, the travel information communication device 10 enables updating of the current position even in a place where the portable navigation device 30 cannot receive the GPS signal, and furthermore, the portable navigation device 30 can be freely installed.

It is noted that the in-vehicle apparatus, to which the travel information communication device 10 outputs the position data, may be a power train control ECU, which controls a power train mechanism such as an automatic transmission apparatus. In this case, the power train control ECU may cause the power train mechanism to generate a driving torque or a braking torque demanded in dependence upon a geographic feature of the current position. Specifically, the power train control ECU may cause the power train mechanism to perform gear change to increase the driving torque when the current position is an uphill. Alternatively, the power train control ECU may cause the power train mechanism to perform gear change to increase the braking torque when the current position is a downhill. Thus, fuel consumption of the self-vehicle can be reduced.

In particular, when the self-vehicle is a hybrid vehicle or an electromobile, the in-vehicle apparatus, to which the travel information communication device 10 outputs the position data, may be a charging and discharging control apparatus for controlling charge and discharge of a battery. In this case, the charging and discharging control apparatus may specify whether the current position is an uphill or a downhill. In addition, the charging and discharging control apparatus may control a time point of charging and discharging of the battery according to the specified current position. Thus, remaining power of the battery can be maintained within a suitable range specified beforehand.

The travel information communication device 10 according to the present embodiment may be connected with a diagnostic port provided to a communication line for performing a diagnostic operation to examine a failure of the self-vehicle, or the like. In this case, an exclusive connection port need not be provided. Thus, increase in a number of components can be restricted.

### OTHER EMBODIMENTS

In the embodiment, the specified interval is set to 20 ms, and the set interval is set to 100 ms. It is noted that, the specified interval and the set interval may be arbitrary determined. As described above, when the specified interval is less than the set interval, the yaw rate can be obtained more frequently as compared with the vehicle speed. Therefore, the angle of the self-vehicle, which is apt to frequently change, can be frequently updated at a small interval. Thus, the angle of the self-vehicle can be accurately detected.

The travel information according to the embodiment includes the travel distance and the traveling direction. It is noted that, the travel information may include various information in addition to the travel distance. The travel information may include only the travel distance.

The travel information communication device 10 according to the embodiment performs the data communications with the portable navigation device 30 via the near-field wireless communications in compliance with the Bluetooth standard. It is noted that the near-field wireless communications need not be compliance with the Bluetooth standard. For example, the near-field wireless communications may be, for example, an infrared communications and may be another kind of communications. That is, another communication method may be arbitrary employed to perform a near-field wireless communications.

In the embodiment, the in-vehicle device group 8 is installed in an automobile. It is noted that the in-vehicle device group 8 may be provided to another vehicle such as a motorcycle. That is, the navigation system 1 may be applied to a motorcycle.

The PND interface unit 13 in the embodiment is equivalent to a communication unit and an information obtaining unit. The travel information generating unit 12 in the embodiment is equivalent to an information generating unit, a transmission control unit, and an information output unit.

The control unit 37 in the embodiment is equivalent to a current position deriving unit and a position estimating unit. The communication unit 32 in the embodiment is equivalent to a travel information obtaining unit, a position information transmission unit, and a navigation communication unit.

The information communication device may be carried by an occupant of the vehicle when being used.

Summarizing the above embodiments, a information communication device for a movable object includes:

a communication unit configured to communicate information via near-field wireless communications;

an information generating unit configured to derive a travel distance, by which the movable object has moved in a specified time period, and generate travel information including at least the derived travel distance; and

a transmission control unit configured to transmit the travel information to a portable navigation device via the communication unit.

The portable navigation device includes:

a GPS receiver configured to receive a signal from a GPS satellite;

a current position deriving unit configured to successively derive a current position according to the signal received by the GPS receiver; and

a position estimating unit configured to estimate a current position moved from the current position derived by the current position deriving unit according to the travel information derived by the travel information deriving unit.

That is, the portable navigation device, which obtains the travel information transmitted from the information communication device, is capable of estimate and update the current position, even when the GPS signal is not receivable.

In addition, the information communication device transmits the travel information via the near-field wireless communications. Therefore, the portable navigation device may be located at various positions, as long as being capable of receiving the travel information. Therefore, the installation position of the portable navigation device can be arbitrary selected by a user.

In other words, the information communication device enables updating of the current position even in a place where the portable navigation device cannot receive the GPS signal, and furthermore, the portable navigation device can be freely installed at various positions.

The information generating unit may be configured to derive a traveling direction of the movable object and may be configured to generate the travel information to include the derived traveling direction in addition to the travel distance.

In addition to the travel distance, the information communication device transmits the traveling direction as the travel information to the portable navigation device. Therefore, accuracy of the estimation of the current position of the portable navigation device can be enhanced when the portable navigation device is incapable of receiving the GPS signal.

The communication unit may be configured to communicate information via near-field wireless communications in compliance with an infrared communication standard. Alternatively, the communication unit may be configured to communicate information via near-field wireless communications in compliance with the Bluetooth (registered trademark) standard.

In the latter Bluetooth (registered trademark) case, even when an object exists between the information communication device and the portable navigation device, the portable navigation device can receive the travel information. Accordingly, the installation position of the portable navigation device can be further arbitrary determined.

The information communication device and the portable navigation device may constitute a navigation system. The information communication device constituting the navigation system includes the communication unit, the information generating unit, and the transmission control unit. The portable navigation device constituting the navigation system includes the GPS receiver, the current position deriving unit, the travel information obtaining unit, and the position estimating unit.

In the navigation system, the communication unit of the information communication device may be configured to perform two-way communications. In this case, the portable navigation device may include a position information transmission unit configured to transmit the current position derived by the current position deriving unit or the current position estimated by the position estimating unit. In this case, the information communication device may be configured to output the current position, which is derived by the portable navigation device, to an apparatus of the movable object.

That is, in the information communication device of the navigation system, the information obtaining unit may be configured to obtain the current position derived by the portable navigation device via the communication unit. In addition, the information output unit may be configured to output the obtained current position to an apparatus of the movable object.

For example, the apparatus, to which the portable navigation device outputs the determined current position, may be a generally-known control device configured to determine whether the current position is an uphill or a downhill and configured to control a power train mechanism of an automobile such as an automatic transmission apparatus to cause a demanded torque according to the determination. In this case, fuel consumption of the automobile can be reduced.

The above processings such as calculations, determinations, and estimation are not limited being executed by the units such as the meter control device 2, the VSC control device 3, the information communication device 10, and the control unit 37. The control unit may have various structures including the above-described units shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. An information communication device mounted to a movable object, the information communication device comprising:
a communication unit for communicating information via near-field wireless communications;
an information generating unit configured to derive a derived travel distance; by which the movable object moves in a predetermined time period, and configured to generate travel information including at least the derived travel distance; and
a transmission control unit configured to transmit the travel information, which is generated by the information generating unit, to a portable navigation device via the communication unit,
wherein the portable navigation device including:
a GPS receiver configured to receive a signal from a GPS satellite;
a current position deriving unit configured to successively derive a derived current position according to the signal received by the GPS receiver;
a travel information obtaining unit configured to obtain the travel information from the information generating unit; and
a position estimating unit configured to estimate an estimated current position moved from a previous derived current position, which is previously derived by the current position deriving unit, according to the travel information obtained by the travel information obtaining unit.

2. The information communication device according to claim 1, wherein
the information generating unit is configured to derive a traveling direction of the movable object, and
the information generating unit is configured to generate the travel information including the derived traveling direction and the travel distance.

3. The information communication device according to claim 1, wherein the communication unit is configured to perform the near-field wireless communications in compliance with a Bluetooth standard.

4. A navigation system comprising:
the information communication device according to claim 1; and
the portable navigation device.

5. The navigation system according to claim 4, wherein
the communication unit is configured to perform two-way communications,
the portable navigation device further includes:
a position information transmission unit configured to transmit the derived current position, which is derived by the current position deriving unit, or the estimated current position, which is estimated by the position estimating unit, and
the information communication device further includes:
a navigation information obtaining unit Configured to obtain the derived current position or the estimated current position transmitted from the position information transmission unit of the portable navigation device via the communication unit; and
an information output unit configured to output the derived current position or the estimated current position, which is obtained by the navigation information obtaining unit, to an apparatus of the movable object.

6. An information communication device according to claim 1, wherein the position estimating unit is configured to estimate the estimated current position by adding the derived travel distance to the previous derived current position.

7. A portable navigation device comprising:
a GPS receiver configured to receive a signal from a GPS satellite;
a current position deriving unit configured to successively derive a current position according to the signal received by the GPS receiver;
a navigation communication unit for communicating information with an information communication device, which is mounted to a movable object, via near-field wireless communications;
a travel information obtaining unit configured to obtain travel information from the information communication device via the near-field wireless communications by using the navigation communication unit, the travel information being generated by the information communication device to include at least a derived travel distance derived by the information communication device, the derived travel distance specifying a distance, by which the movable object moves in a predetermined time period; and
a position estimating unit configured to estimate an estimated current position moved from a previous current position, which is previously derived by the current position deriving unit, according to the obtained travel information.

8. The method according to claim 7, wherein the position estimating unit is configured to estimate the estimated current position by adding the derived travel distance to the previous derived current position.

9. A method for estimating a current position of a movable object, the method comprising:
deriving a travel distance, by which the movable object moves in a predetermined time period, by an information communication device mounted to the movable object;
transmitting the derived travel distance by the information communication device to a portable navigation device via near-field wireless communications;
obtaining the travel information by the portable navigation device;
successively deriving a derived current position by the portable navigation device according to a signal transmitted from a GPS satellite and received by a GPS receiver; and
estimating an estimated current position, which is presently moved from a previously derived current position, by the portable navigation device according to the previously derived current position and the derived travel distance.

10. The method according to claim 9, wherein the estimating includes
estimating the estimated current position by the portable navigation device by adding the previously derived current position to the derived travel distance.
